(19) United States
(12) Patent Application Publication
(10) Pub. No.: US 2018/0209397 A1
(43) Pub. Date: Jul. 26, 2018

(54) WATER-FLOW POWER DEVICE

(71) Applicant: CHIN-LI PAI, KAOHSIUNG (TW)

(72) Inventor: CHIN-YEN PAI, KAOHSIUNG CITY (TW)

(21) Appl. No.: 15/662,918

(22) Filed: Jul. 28, 2017

(30) Foreign Application Priority Data
Jan. 24, 2017 (TW) 106102561

(51) Int. Cl. F03B 17/06; F03B 13/18

(52) U.S. Cl. CPC F03B 17/066; F05B 2260/505; F03B 13/184; F03B 17/061

(57) ABSTRACT

A water-flow power device includes a carrier, a first sprocket component, a second sprocket component, a first chain, a second chain, a plurality of blade structures, and an energy conversion unit. The carrier has a first end portion and a second end portion opposite to the first end portion. The first sprocket component is disposed at the first end portion of the carrier. The second sprocket component is disposed at the second end portion of the carrier. The first chain is configured to surround the first sprocket component and the second sprocket component. The second chain is configured to surround the first sprocket component and the second sprocket component. Two ends of each of the blade structures are respectively connected to the first chain and the second chain. The energy conversion unit is connected to the first sprocket component or the second sprocket component.

### FIELD

The disclosure relates to a power device, more particular to a water-flow power device.

### BACKGROUND

A water-flow power generation device is an apparatus that can generate power by using ocean currents, tides, or rivers, and needs to be equipped with a mechanism that can convert water-flow kinetic energy into mechanical energy and electric energy in order. For example, in “sea-current power generation apparatus” of TW Patent No. 1526609, a mechanical energy is generated by pushing rotating blades by using water flows, and the mechanical energy is then converted into electric energy by using a power generator. However, the power structure design of the foregoing sea-current power generation apparatus is not desirable. The sea-current power generation apparatus can work only in high-flowing speed (>3 m/s) water flows, and is cannot normally work if being placed in ocean currents or sea currents whose average flowing speed is lower than 1 m/s.

### SUMMARY OF THE INVENTION

In accordance with one aspect of the present disclosure, a water-flow power device includes a carrier, a first sprocket component, a second sprocket component, a first chain, a second chain, a plurality of blade structures, and an energy conversion unit. The carrier has a first end portion and a second end portion opposite to the first end portion. The first sprocket component is disposed at the first end portion of the carrier. The second sprocket component is disposed at the second end portion of the carrier. The first chain is configured to surround the first sprocket component and the second sprocket component. The second chain is configured to surround the first sprocket component and the second sprocket component. The second chain is spaced from the first chain. The blade structures are spaced from each other. Two ends of each of the blade structures are respectively connected to the first chain and the second chain. The energy conversion unit is connected to the first sprocket component or the second sprocket component.

### BRIEF DESCRIPTION OF THE DRAWINGS

Aspects of the present disclosure are understood from the following detail flapped description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 shows an exploded perspective view of a water-flow power device in accordance with some embodiments of the present disclosure.

FIG. 2 shows an assembled perspective view of a water-flow power device in accordance with some embodiments of the present disclosure.

FIG. 3 shows an assembled front view of a water-flow power device in accordance with some embodiments of the present disclosure.

FIG. 4 shows an assembled perspective view of a first chain, a second chain, a first sprocket, and a second sprocket in accordance with some embodiments of the present disclosure.

FIG. 5 shows an enlarged view of blade structures connecting to a first chain and a second chain in accordance with some embodiments of the present disclosure.

FIG. 6 shows a perspective view of a blade structure in accordance with some embodiments of the present disclosure.

FIG. 7 shows a schematic view of a tail flap of a blade structure connecting to a first chain through a first positioning component in accordance with some embodiments of the present disclosure.

FIG. 8 shows a schematic view of a tail flap of a blade structure connecting to a second chain through a second positioning component in accordance with some embodiments of the present disclosure.

FIG. 9 shows a schematic view of actions of blade structures, a first chain, and a second chain in accordance with some embodiments of the present disclosure.

### DETAIL FLAPPED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present is disclosure to those of ordinary skill in the art. It will be apparent, however, that one or more embodiments may be practiced without these specific detail flaps.

In addition, the present disclosure may repeat reference numerals and/or letters in the various examples. This repetition is for the purpose of simplicity and clarity and does not in itself dictate a relationship between the various embodiments and/or configurations discussed.

It will be understood that singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

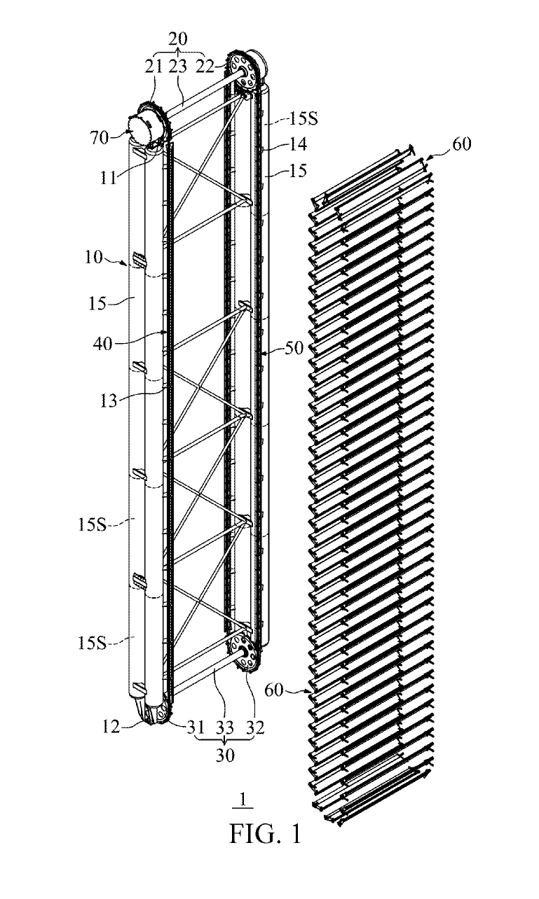

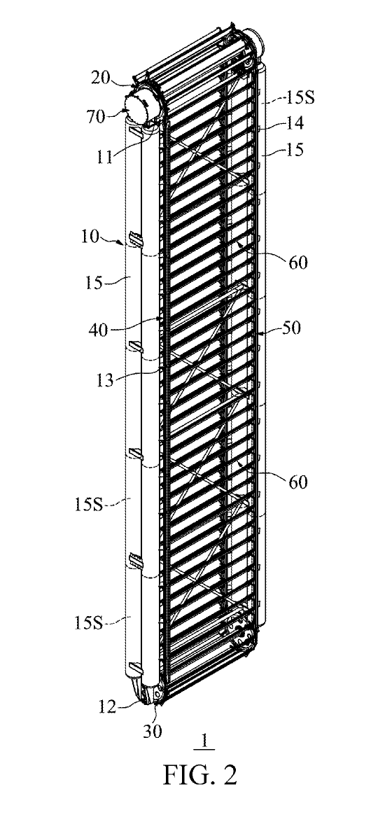

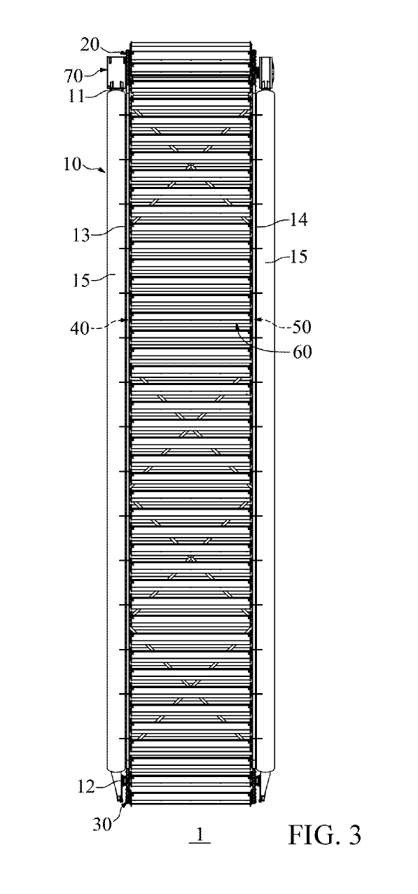

FIG. 1 shows an exploded perspective view of a water-flow power device in accordance with some embodiments of the present disclosure. FIG. 2 shows an assembled perspective view of a water-flow power device in accordance with some embodiments of the present disclosure. FIG. 3 shows an assembled front view of a water-flow power device in accordance with some embodiments of the present disclosure. Referring to FIG. 1, FIG. 2 and FIG. 3, a water-flow power device 1 of the present disclosure includes a carrier 10, a first sprocket component 20, a second sprocket component 30, a first chain 40, a second chain 50, a plurality of blade structures 60, and an energy conversion unit 70.

The carrier 10 has a first end portion 11, a second end portion 12, a first side portion 13, a second side portion 14, and two buoyancy adjusting pipes 15. The second end portion 12 is opposite to the first end portion 11. The first side portion 13 extends between the first end portion 11 and the second end portion 12. The second side portion 14 is opposite to the first side portion 13, and also extends between the first end portion 11 and the second end portion 12. The two buoyancy adjusting pipes 15 are disposed at the first side portion 13 and the second side portion 14, respectively. In the present embodiment, the two buoyancy adjusting pipes 15 extend between the first end portion 11 and the second end portion 12.

A plurality of separation compartments 15S are provided within each of the buoyancy adjusting pipes 15, wherein a high-pressure gas and freshwater are injected into each of the separation compartments 15S, so as to adjust an overall buoyancy of the water-flow power device 1. Moreover, considering an accumulation of an operation time, a weight of the water-flow power device 1 is increased because an external portion of the carrier 10 is easy to be attached by marine organisms. Buoyancy adjustment of each of the buoyancy adjusting pipes 15 is offsetting an additional load generated by an increase of the marine organisms by managing a water-storage capacity of each of the separation compartments 15S. In addition, injecting the high-pressure gas into each of the buoyancy adjusting pipes 15 can also prevent a water pressure from compressing the buoyancy adjusting pipes 15. In one or more embodiments, each of the buoyancy adjusting pipes 15 is a hollow cylindrical pipe, which can effectively resist squeezing caused by an external water pressure, can simultaneously reduce a strength required by a material, and can also effectively reduce the weight of the water-flow power device 1.

The first sprocket component 20 is disposed at the first end portion 11 of the carrier 10. The first sprocket component 20 has a first sprocket portion 21, a second sprocket portion 22, and a first connecting rod 23. Two ends of the first connecting rod 23 are connected to the first sprocket portion 21 and the second sprocket portion 22, respectively.

The second sprocket component 30 is disposed at the second end portion 12 of the carrier 10. The second sprocket component 30 has a third sprocket portion 31, a fourth sprocket portion 32, and a second connecting rod 33. The third sprocket portion 31 corresponds to the first sprocket portion 21. The fourth sprocket portion 32 corresponds to the second sprocket portion 22. Two ends of the second connecting rod 33 are connected to the third sprocket portion 31 and the fourth sprocket portion 32, respectively.

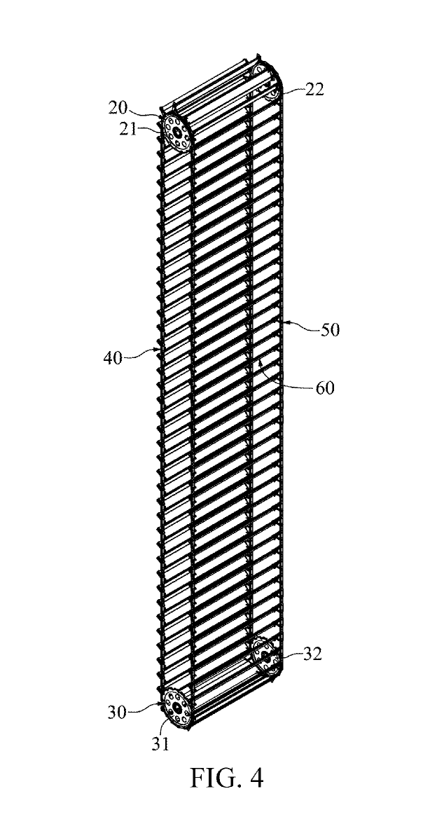

FIG. 4 shows an assembled perspective view of a first chain, a second chain, a first sprocket, and a second sprocket in accordance with some embodiments of the present disclosure. Referring to FIG. 2 and FIG. 4, the first chain 40 is configured to surround the first sprocket component 20 and the second sprocket component 30. In the present embodiment, the first chain 40 is configured to surround the first sprocket portion 21 of the first sprocket component 20 and the third sprocket portion 31 of the second sprocket component 30.

The second chain 50 is configured to surround the first sprocket component 20 and the second sprocket component 30, and is spaced from the first chain 40. In the present embodiment, the second chain 50 is configured to surround the second sprocket portion 22 of the first sprocket component 20 and the fourth sprocket portion 32 of the second sprocket component 30.

In order to enable the first chain 40 and the second chain 50 to transmit synchronously, in one or more embodiments, a length of the first chain 40 is equal to that of the second chain 50.

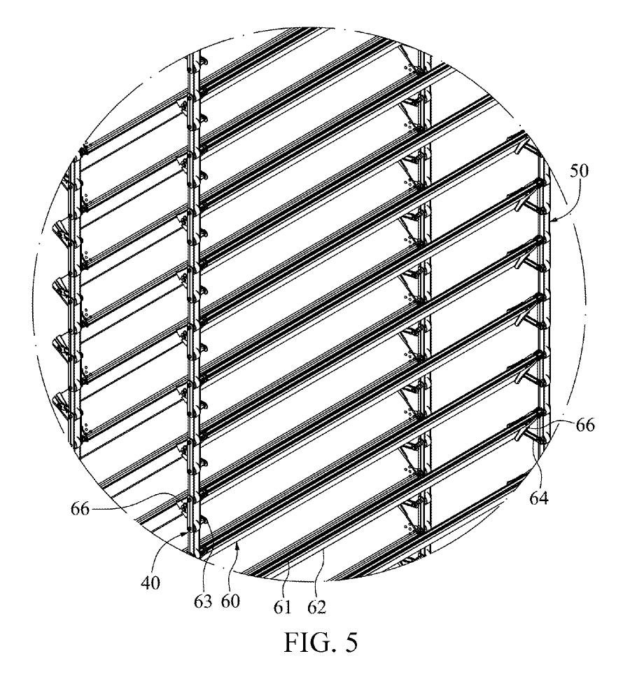

FIG. 5 shows an enlarged view of blade structures connecting to a first chain and a second chain in accordance with some embodiments of the present disclosure. Referring to FIG. 1, FIG. 2 and FIG. 5, the blade structures 60 are spaced from each other, and two ends of each of the blade structures 60 are connected to the first chain 40 and the second chain 50, respectively.

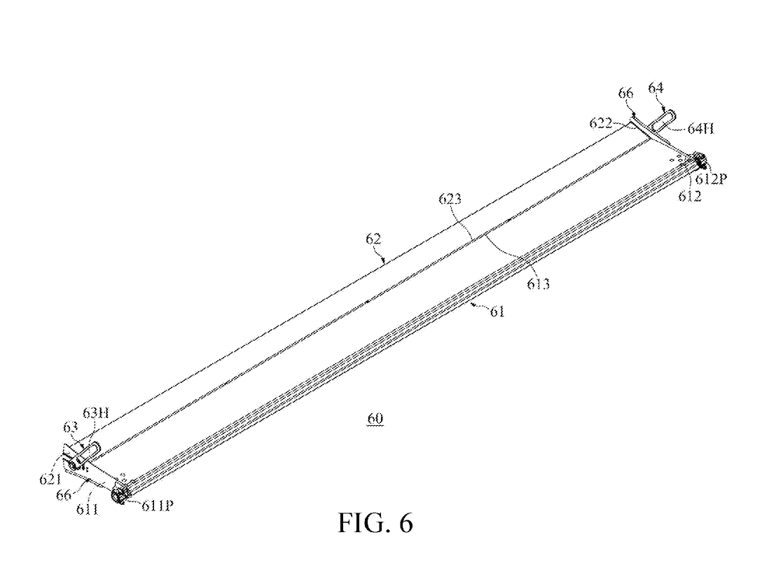

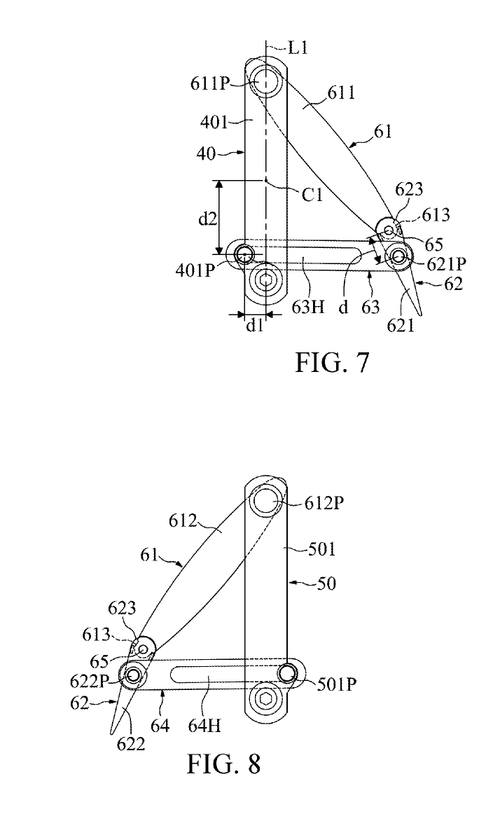

FIG. 6 shows a perspective view of a blade structure in accordance with some embodiments of the present disclosure. FIG. 7 shows a schematic view of a tail flap of a blade structure connecting to a first chain through a first positioning component in accordance with some embodiments of the present disclosure. Referring to FIG. 5, FIG. 6 and FIG. 7, each of the blade structures 60 at least includes a blade body 61 and a tail flap 62.

Each of the blade bodies 61 has a first end 611, a second end 612, and a side portion 613. Each of the first ends 611 is connected to the first chain 40. Each of the second ends 612 is opposite to each of the first ends 611, and is connected to the second chain 50. Each of the side portions 613 extends between each of the first ends 611 and each of the second ends 612. In the present embodiment, each of the first ends 611 has a first pivoting portion 611P; each of the second ends 612 has a second pivoting portion 612P; each of the first ends 611 is pivoted to the first chain 40 by using each of the first pivoting portions 611P; and each of the second ends 612 is pivoted to the second chain 50 by using each of the second pivoting portions 612P.

Each of the tail flaps 62 has a third end 621, a fourth end 622, and a side connecting portion 623. Each of the fourth ends 622 is opposite to each of the third ends 621. Each of the side connecting portions 623 extends between each of the third ends 621 and each of the fourth ends 622. Moreover, each of the side connecting portions 623 is pivoted to the side portion 613 of each of the blade bodies 61, so that each of the tail flaps 62 can swing up and down.

FIG. 8 shows a schematic view of a tail flap of a blade structure connecting to a second chain through a second positioning component in accordance with some embodiments of the present disclosure. Referring to FIG. 6, FIG. 7 and FIG. 8, in order to control a swinging angle of each of the tail flaps 62, in the present embodiment, each of the blade structures 60 further includes a first positioning component 63 and a second positioning component 64. Two ends of each of the first positioning components 63 are connected to the first chain 40 and the third end 621 of each of the tail flaps 62, respectively. Two ends of each of the second positioning components 64 are connected to the second chain 50 and the fourth end 622 of each of the tail flaps 62, respectively.

In the present embodiment, one end of each of the first positioning components 63 is connected to a first link plate 401 of the first chain 40, and the other end of each of the first positioning components 63 is connected to a pivot 621P of each of the third ends 621. Each of the first link plates 401 has a first eccentric pivot 401P, and is defined to have a first center line L1 and a first center point C1. In addition, a horizontal distance d1 is between a center of each of the first eccentric pivots 401P and each of the first center lines L1, and a vertical distance d2 is between the center of each of the first eccentric pivots 401P and each of the first center points C1, in the present embodiment, the vertical distance d2 is greater than the horizontal distance d1. Or, in another embodiment, the vertical distance d2 may be smaller than or equal to the horizontal distance d1.

In the present embodiment, one end of each of the second positioning components 64 is connected to a second link plate 501 of the second chain 50, and the other end of each of the second positioning components 64 is connected to a pivot 622P of each of the fourth ends 622. Each of the second link plates 501 has a second eccentric pivot 501P. A structure configuration of each of the second link plates 501 is the same as that of each of the first link plates 401, and therefore details are not described herein again.

Each of the blade bodies 61 is driven to swing while each of the tail flaps 62 swings. Therefore, each of the first positioning components 63 and each of the second positioning components 64 also have a function of controlling a swinging angle of each of the blade bodies 61.

Furthermore, in order to enable each of the blade bodies 61 and each of the tail flaps 62 to automatically adjust the swinging angle according to a water flow pushing force, in the present embodiment, each of the first positioning components 63 has a first sliding slot 63H, wherein each of the first sliding slots 63H is pivoted to the first eccentric pivot 401P of each of the first link plates 401. Each of the first positioning components 63 can move with respect to each of the first link plates 401. That is, each of the first eccentric pivots 401P is located within each of the first sliding slots 63H, and can slide in each of the first sliding slots 63H with respect to each of the first positioning components 63. Each of the second positioning components 64 has a second sliding slot 64H. Each of the second sliding slots 64H corresponds to each of the first sliding slots 63H, and is pivoted to the second eccentric pivot 501P of each of the second link plates 501. Each of the second positioning components 64 can move with respect to each of the second link plates 501. That is, each of the second eccentric pivots 501P is located within each of the second sliding slots 64H, and can slide in each of the second sliding slots 64H with respect to each of the second positioning components 64. Alternatively, each of the first positioning components 63 can slide along a length direction of each of the first sliding slots 63H by using each of the first eccentric pivots 401P as a fulcrum; and each of the second positioning components 64 can slide along a length direction of each of the second sliding slots 64H by using each of the second eccentric pivots 501P as a fulcrum, so as to adjust their own positions, and thereby adjusting swinging angles of each of the tail flaps 62 and each of the blade bodies 61.

In one or more embodiments, a length of each of the first sliding slots 63H is equal to that of each of the second sliding slots 64H.

In one or more embodiments, each of the blade structures 60 can use a pivoting rod 65 to pass through the side portion 613 of each of the blade bodies 61 and the side connecting portion 623 of each of the tail flaps 62, so that each of the pivoting rods 65 may serve as a pivot when each of the tail flaps 62 swings. Furthermore, a distance d is between a center of each of the pivoting rods 65 and a center of the pivot 621P of each of the third ends 621.

In addition, as shown in FIG. 6, in order to avoid the water flowing around the two ends of each of the blade structures 60, each of the blade structures 60 further includes two side baffling plates 66. The two side baffling plates 66 are disposed at the first end 611 and the second end 612 of each of the blade bodies 61, respectively. Moreover, a length of each of the side baffling plates 66 extends to each of the tail flaps 62, so that each of the tail flaps 62 is located between the two side baffling plates 66. The two side baffling plates 66 can inhibit the water from flowing around the two ends of each of the blade structures 60, can enable the water flow to completely act on each of the blade bodies 61 and each of the tail flaps 62, and can reduce an oscillation of each of the blade structures 60.

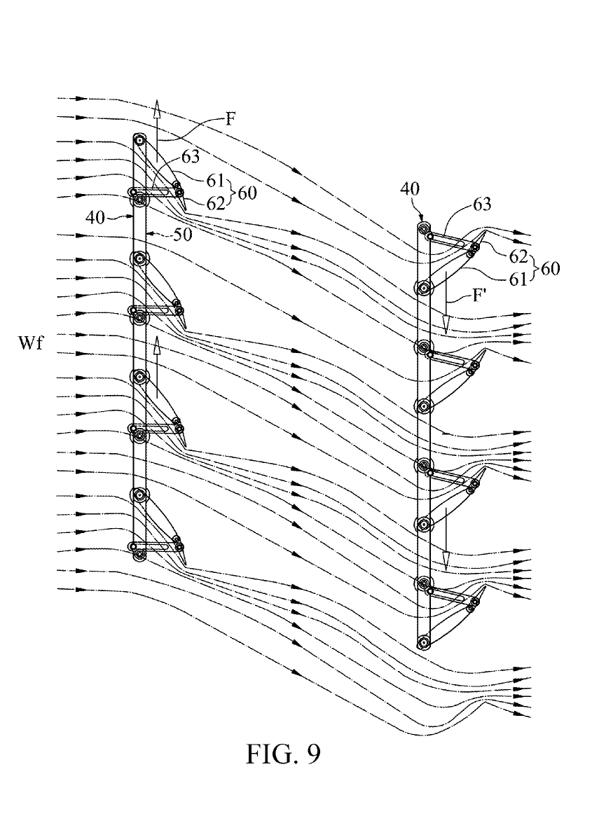

FIG. 9 shows a schematic view of actions of blade structures, a first chain, and a second chain in accordance with some embodiments of the present disclosure. Referring to FIG. 4, FIG. 6, and FIG. 9, when the water flow pushing force Wf acts on a front column of the blade structures 60, the blade bodies 61 swing upward and the tail flaps 62 swing downward according to the action of the water flow pushing force Wf and the position differences of the rotation axles, and are positioned by each of the first positioning components 63 and each of the second positioning components 64 (at this time, an included angle between each of the first positioning components 63 and the first chain 40 is about 90°, and an included angle between each of the second positioning components 64 and the second chain 50 is also about 90°), to convert the water flow pushing force Wf into an elevating force F of the front column, so as to push the first chain 40 and the second chain 50 to move upward, and synchronously drive the first sprocket component 20 and the second sprocket component 30 to rotate. Then, the flowing directions of water flows that flow through the front column of the blade structures 60 are changed, and the water flow pushing force Wf continues to act on a rear column of the blade structures 60. Meanwhile, the blade bodies 61 change to swing downward and the tail flaps 62 change to swing upward due to the changed flowing directions and speeds (at this time, the included angle between each of the first positioning components 63 and the first chain 40 is less than 90°, and the included angle between each of the second positioning components 64 and the second chain 50 is also less than 90°), so as to obtain an elevating force F′ of the rear column. The elevating force F′ of the rear column has a value close to a value of the elevating force F of the front column obtained from conversion by the front column of the blade structures 60, and has a direction that is reverse to a direction of the elevating force F of the front column, so as to push the first chain 40 and the second chain 50 to move downward, and synchronously drive the first sprocket component 20 and the second sprocket component 30 to rotate. In other words, the water flow pushing forces Wf in a same section can respectively act on the front column and rear column of the blade structures 60. By means of the first chain 40 and the second chain 50, the elevating force F of the front column and the elevating force F′ of the rear column obtained from the conversion by the blade structures 60 can be accumulated, thereby achieving maximum power output.

Angles of attack of the front column and rear column of the blade structures 60 are designed to enable the water-flow power device 1 to obtain the maximum energy, and have an effect that the flowing speed of the water flow passing through the front column of blade structures 60 is partially accelerated, wherein the flowing directions satisfy requirements of angles of attack of the rear column of the blade structures 60. Further, the flowing directions of water flows passing through the rear column of the blade structures 60 are also recovered to be parallel to the flowing directions of water flows at an inlet of the front column of the blade structures 60. Accordingly, for the water flows passing through the water-flow power device 1, flowing directions of former and later flow fields are consistent and wake flows are stable, thereby significantly reducing effects on the environment.

Referring to FIG. 1, FIG. 2 and FIG. 3 again, an energy conversion unit 70 is connected to the first sprocket component 20; perhaps in another embodiment, the energy conversion unit 70 is connected to the second sprocket component 30. In the present embodiment, the energy conversion unit 70 is an axial power generating device. A rotation shaft (not shown in the figures) of the axial power generating device may be connected to the first sprocket component 20, so as to enable the first sprocket component 20 to drive the axial power generating device to generate electricity while rotating. Perhaps in another embodiment, the energy conversion unit 70 can be a hydraulic device which can be connected to the first sprocket component 20. Moreover, the water-flow power device 1 can further include a power generating device (not shown in the figures). The power generating device is connected to the hydraulic device, and may be disposed above or below a water surface. When the first sprocket component 20 rotates, the hydraulic device can be driven, and the hydraulic device further drives the power generating device to generate electricity.

The water-flow power device 1 of the present disclosure can normally work in ocean currents or sea currents whose average flowing speed is lower than 1 m/s, which facilitates wide development of ocean-current or sea-current power generation.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. A water-flow power device, comprising:
a carrier having a first end portion and a second end portion opposite to the first end portion;
a first sprocket component disposed at the first end portion of the carrier;
a second sprocket component disposed at the second end portion of the carrier;
a first chain configured to surround the first sprocket component and the second sprocket component;
a second chain configured to surround the first sprocket component and the second sprocket component, wherein the second chain is spaced from the first chain;
a plurality of blade structures spaced from each other, wherein two ends of each of the blade structures are respectively connected to the first chain and the second chain; and
an energy conversion unit connected to the first sprocket component or the second sprocket component.

2. The water-flow power device of claim 1, wherein the carrier has a first side portion, a second side portion and two buoyancy adjusting pipes, the second side portion is opposite to the first side portion, and the two buoyancy adjusting pipes are respectively disposed at the first side portion and the second side portion.

3. The water-flow power device of claim 2, wherein a plurality of separation compartments are provided within each of the buoyancy adjusting pipes, and a high-pressure gas and freshwater are injected into each of the separation compartments.

4. The water-flow power device of claim 1, wherein the first sprocket component has a first sprocket portion, a second sprocket portion, and a first connecting rod, two ends of the first connecting rod are respectively connected to the first sprocket portion and the second sprocket portion, the second sprocket component has a third sprocket portion corresponding to the first sprocket portion, a fourth sprocket portion corresponding to the second sprocket portion, and a second connecting rod, and two ends of the second connecting rod are respectively connected to the third sprocket portion and the fourth sprocket portion.

5. The water-flow power device of claim 4, wherein the first chain is configured to surround the first sprocket portion of the first sprocket component and the third sprocket portion of the second sprocket component.

6. The water-flow power device of claim 4, wherein the second chain is configured to surround the second sprocket portion of the first sprocket component and the fourth sprocket portion of the second sprocket component.

7. The water-flow power device of claim 1, wherein each of the blade structures at least comprises a blade body and a tail flap, each of the blade bodies has a side portion, each of the tail flaps has a side connecting portion, and the side connecting portion of each of the tail flaps is pivoted to the side portion of each of the blade bodies.

8. The water-flow power device of claim 7, wherein each of the blade bodies has a first end and a second end, each of the first ends is connected to the first chain, each of the second ends is connected to the second chain, and each of the side portions extends between each of the first ends and each of the second ends.

9. The water-flow power device of claim 8, wherein each of the blade structures further comprises a first positioning component and a second positioning component, each of the tail flaps has a third end and a fourth end, two ends of each of the first positioning components are respectively connected to the first chain and the third end of each of the tail flaps, and two ends of each of the second positioning components are respectively connected to the second chain and the fourth end of each of the tail flaps.

10. The water-flow power device of claim 9, wherein each of the first positioning components has a first sliding slot, each of the second positioning components has a second sliding slot, and each of the second sliding slots corresponds to each of the first sliding slots.

11. The water-flow power device of claim 10, wherein one end of each of the first positioning components is connected to a first link plate of the first chain, each of the first link plates has a first eccentric pivot, and each of the first sliding slots is pivoted to the first eccentric pivot of each of the first link plates.

12. The water-flow power device of claim 11, one end of each of the second positioning components is connected to a second link plate of the second chain, each of the second link plates has a second eccentric pivot, and each of the second sliding slots is pivoted to the second eccentric pivot of each of the second link plates.

13. The water-flow power device of claim 9, wherein one end of each of the first positioning components is connected to a first link plate of the first chain, each of the first link plates has a first eccentric pivot and is defined to have a first center line and a first center point, a horizontal distance is between a center of each of the first eccentric pivots and each of the first center lines, and a vertical distance is between the center of each of the first eccentric pivots and each of the first center points.

14. The water-flow power device of claim 9, wherein each of the blade structures further comprises a pivoting rod used to pass through the side portion of each of the blade bodies and the side connecting portion of each of the tail flaps, and a distance is between a center of each of the pivoting rods and a center of a pivot of each of the third ends.

15. The water-flow power device of claim 7, wherein each of the blade structures further comprises a pivoting rod used to pass through the side portion of each of the blade bodies and the side connecting portion of each of the tail flaps.

16. The water-flow power device of claim 7, wherein each of the blade structures further comprises two side baffling plates, each of the blade bodies has a first end and a second end, and the two side baffling plates are respectively disposed at the first end and the second end of each of the blade bodies.

17. The water-flow power device of claim 1, wherein the energy conversion unit is an axial power generating device.

18. The water-flow power device of claim 1, wherein the energy conversion unit is a hydraulic device.

19. The water-flow power device of claim 18, further comprising a power generating device, wherein the power generating device is connected to the hydraulic device.
